(19) United States
(12) Patent Application Publication
(10) Pub. No.: US 2004/0156350 A1
(43) Pub. Date: Aug. 12, 2004

(54) Hybrid polling/contention MAC layer with multiple grades of service

(75) Inventors: Joseph Robert Brasic, Cochrane (CA); Daniel Cameron Taylor, Calgary (CA)

Correspondence Address: BENNETT JONES, 4500 Bankers Hall East, 855 - 2nd Street SW, Calgary, AB, T2P 4K7, CA

(73) Assignee: WAVERIDER COMMUNICATIONS INC.

(21) Appl. No.: 10/348,604

(22) Filed: Jan. 22, 2003

(51) Int. Cl. H04J 3/16

(52) U.S. Cl. 370/346; 370/449

(57) ABSTRACT

A method for polling a plurality of wireless modems from a base station in which the base station individually polling all of the modems and forming at least two lists such that each modem is identified on only one discrete list based upon its behavior in response to the polling. Thereafter, the modems identified on each discrete list are polled at a rate that may differ from the rate at which the modems identified on any other list are polled and the lists are updated dynamically based upon the behavior of the modems polled in response to the last polling.

### FIELD

This invention relates generally to the field of network management and in particular to a method for efficient polling of wireless modems.

### BACKGROUND

A wireless modem is a data communication device that comprises at least two data communication ports, at least one of which is a wireless data port enabling the wireless modem to communicate with one or more other wireless modems via a radio frequency (“RF”) link. The other communication ports, each of which may be connected to a single computer or a data network, may be wire-line, such as Ethernet, USB, or RS232, or wireless. This second link may even be internal to a device or virtual if the modem is internal to the target computer. To simplify the following description, we will consider a wireless modem to have two communication ports—one an RF link for communicating with other wireless modems and the other a wire-line link for communication with a single computer or a data network. Ethernet will be used as an exemplary protocol for the wire-line link in the following discussion.

Wireless modems are typically used to link together wire-line data networks or computers that are geographically separated. The wireless modems act as bridges or routers between the wire-line data networks. An example of such use, in a “point-to-point” configuration, is shown in FIG. 1. A first local area network 10 is connected by wire-line 12 to a first wireless modem 14. Similarly a second local area network 16 is connected by wire-line 18 to a second wireless modem 20. The two wireless modems 14, 20 communicate via an RF link 22, shown connecting wireless modem 14 with wireless modem 20 through the free space separating the modems 14, 20.

Wireless modems are also used in point to multi-point wireless data communication networks, such as that shown in FIG. 3 and indicated generally by reference numeral 42. In point to multi-point wireless data communication network 42, a special form of wireless modem, base station 44, is connected by wire-line 45 to a data network 43. Base station 44 receives data from data network 43 and transmits it to a group of wireless modems of a special form, known as terminals, a representative four of which are indicated by reference numerals 46, 48, 50, and 52 in FIG. 3, via RF links 54, 56, 58, 60, respectively. The terminals 46, 48, 50, 52 in turn send data via RF links 54, 56, 58, 60, respectively, directly to base station 44 (i.e., terminals 46, 48, 50, 52 do not communicate directly with each other, though they may communicate through the base station). Data transmitted from base station 44 to a terminal 46, 48, 50 or 52 is known as “forward traffic” and is grouped in units of “forward payloads.” Data transmitted from a terminal 46, 48, 50 or 52 to base station 44 is known as “reverse traffic” and is grouped in units of “reverse payloads.” One common application of a point to multi-point wireless data communication network 42 is to connect a group of end users, each with one or more terminals 46, 48, 50, 52, to the Internet (an example of a data network 43) via the base station 44, which is maintained by an Internet Service Provider (ISP). The point to multi-point wireless data communication network 42 allows the ISP to provide Internet connectivity to its customers in a geographic area in a timely and cost efficient manner.

In order for wireless modems to be used in a variety of data networks supporting different communication protocols, and to facilitate efficient operation on their RF links, wireless modems typically use protocol layering. Regardless of the protocol used on the wire-line link, when a data packet is received by a wireless modem on its wire-line link and is to be transmitted on its RF link, the wireless modem encapsulates the wire-line data packet within an RF packet containing information specific to the RF link. In essence the wire-line data packet becomes the data payload for the RF data packet. The wireless modem then sends the complete RF packet on its RF link. The wireless modem that receives the packet removes the RF link specific information and then forwards the wire-line portion of the packet (possibly modified) on its wire-line communication port. Alternately, each modem may remove the physical layer protocol portion of the packet, such as the Ethernet header, before adding the RF link specific information, so that the data payload of the RF packet is the data payload of the wire-line packet. The receiving modem then removes the RF link specific information and constructs a suitable physical layer portion before forwarding on the wire-line port.

A typical RF link packet 24 that would be transmitted from wireless modem 14 to wireless modem 20 in FIG. 1 using protocol layering is shown in FIG. 2. The data frame format used is IEEE802.11. Note that this packet may be further encapsulated to support the physical layer. The details of the physical layer are not of interest here. The data contained in RF link packet 24 includes:

Frame Control 26—Control information for the destination wireless modem, in this case wireless modem 20. The information may indicate what type of frame this is, the format and meaning of the following fields, what kind of response is expected from the destination modem and information about the state of the source modem.

Duration 28—Indicates the length of the packet and therefore of the Frame Body.

DA 30—The Destination Address specifically, an address or unique identifier of the wireless modem (“the destination modem”) that is expected to receive RF link packet 24. Since RF is a broadcast medium all wireless modems in the receiving area will receive the RF link packet 24. Only the wireless modem that has this identifier, in this case wireless modem 20, is expected to process RF link packet 24. All other wireless modems receiving RF link packet 24 are expected to discard it.

SA 32—The Source Address specifically, an address or unique identifier of the wireless modem (“the source modem”) that transmitted RF link packet 24, in this case wireless modem 14.

BSSID 34—an identifier of a group to which the source and destination modem belong.

Sequence Control 36—a unique identifier associated with RF link packet 24. Each time the source wireless modem transmits a unique packet on its RF link it changes the ID so that each transmitted RF link packet 24 is uniquely identified. This can be used with an automatic repeat request mechanism to provide for a reliable link.

Frame Body 38—the data payload portion of the RF link packet 24.

FCS 40—the frame check sequence. This is a value that is calculated from all of the other data in the RF link packet 24. The destination modem, here wireless modem 20 recalculates the FCS 40 based on the data it receives. If the calculated value matches the value of the received FCS 40, then the packet is considered to have been correctly received. Otherwise the packet is discarded.

In general, an RF link has a much higher probability of error and therefore higher probability of packet loss than does a wire-line link such as Ethernet. Since many data transport protocols, such as TCP, work best when the packet loss rate due to errors is very low, means to reduce it are often found to improve network performance, even at the expense of raw throughput. One popular and effective means to reduce the packet loss rate is known as automatic repeat request (ARQ). Each packet is identified pseudo-uniquely at the transmitter before transmission, usually with a sequence number, and is stored there until it is determined that the receiver has correctly received it. The receiver then sends an acknowledgement to the transmitter (either by transmitting a packet containing only the acknowledgement or by including an acknowledgement along with the next packet transmitted) that it has correctly received the identified packet. If the transmitter does not receive an acknowledgement for a packet it will retransmit the packet. Variations on this technique are well known to those skilled in the art.

For successful communication to occur, only one wireless modem can be transmitting on an RF channel (RF frequency) at a particular time in a geographic area. In the case being considered, all of the terminals in a point to multi-point network (and possibly the base station as well) transmit on the same RF channel. If more than one attempts to transmit simultaneously, then all transmissions may be corrupted, i.e., they may interfere with each other and the receiver will not be able to decipher any of the transmissions. In order to prevent communications from multiple modems from interfering with each other some method of coordinating access to the RF channel is required. The means of coordination is known as Medium Access Control and is often identified with a Medium Access Control layer (MAC) in a communications model. For example, RF links 54, 56, 58, and 60 shown in FIG. 3 all share the same RF channel, but only one of them can be active at a time if interference is to be avoided.

Access to an RF channel can be coordinated (with a “distributed coordination function”) if the base station or terminal wishing to transmit on the RF channel first listens to determine if any of the terminals, in the case of the base station, or the base station or any of the other terminals, in the case of a terminal, are currently transmitting. While terminals do not communicate directly with each other they are able to determine if another terminal or the base station, is currently transmitting, if it is in range. When neither the base station nor any of the terminals are transmitting, then the RF channel is available and the terminal can transmit. This technique is commonly referred to as “carrier-sense multiple access with collision avoidance” (“CSMA/CA”) and is illustrated in FIG. 4, which shows a portion of network 42. In FIG. 4, terminal 52 has a payload that it wishes to transmit to base station 44. However, at the same time, terminal 46 is already transmitting a payload over RF link 54, which uses the same RF channel that terminal 52 would have to use to transmit to base station 44. Terminal 52 monitors the RF channel, so if it is able to receive the RF signal being broadcast by terminal 46, it waits until terminal 46 stops transmitting before it attempts to transmit its payload. The RF signal received by terminal 52 is indicated by reference numeral 62. While the RF signal broadcast by terminal 46 may radiate in all directions, only RF link 54 and RF signal 62 are shown in FIG. 4.

One of the difficulties with the CSMA/CA technique is that it is possible for two or more wireless modems with payloads to send at the same time to simultaneously sense that the RF channel is free and to begin transmitting at the same time. This is referred to as a collision and results in both transmissions becoming corrupted. Collisions can also occur due to “hidden nodes” in point to multipoint networks. This occurs when a terminal is unable to sense transmissions from one or more of the other terminals due to obstructions or other interference. If one of these terminals is currently transmitting a payload to the base station the hidden node is unable to detect this and may begin its own transmission, which will result in a collision at the base station. For example, in FIG. 5 an obstruction 64 exists between terminal 46 and terminal 52, preventing terminal 52 from receiving RF signal 62. Terminal 52 therefore attempts to transmit a payload over RF link 60 at the same time terminal 46 is transmitting over RF link 54.

As the number of wireless modems and the amount of data to be transmitted increases, the likelihood of a collision increases. Collisions can cause less efficient use of the RF channel.

An improvement to the CSMA/CA technique, that is useful during heavy traffic periods, is to use reservation slots. The group of terminals associated with a base station is divided into subgroups. The base station broadcasts messages to the overall group indicating which subgroup may attempt communication at any given time. Since the number of terminals that may access the media at any given time is reduced the chances for collisions are reduced. Careful selection of the members of a subgroup can also reduce the likelihood of hidden nodes; however, as the number of terminals increases, or the amount of data to be transmitted increases, the likelihood of collisions still increases. The use of reservation slots is not illustrated in the drawings.

Collisions can be completely avoided using polling regardless of high traffic load or hidden nodes. In basic polling, the base station controls the allocation of transmission time by querying (polling) each terminal in round robin fashion. If the terminal has a payload to transmit it responds by sending it to the base station. Otherwise it returns a special packet (a “null response”) indicating that it does not wish to send data, or it does not reply. The base station waits to receive the payload or null response or no response from the terminal and then polls the next terminal. The sequence continues until all terminals have been polled and then repeats. Since only one wireless modem can be transmitting at any time there is no possibility for collision. Polling is illustrated in FIG. 6, in which base station 44 has sent a poll to terminal 46 over RF link 54 and is receiving a payload from terminal 46 over RF link 54. Each terminal 48, 50, and 52 remains inactive until it receives a transmission containing a poll for it from base station 44.

Channel efficiency may be defined as the amount of time spent actually receiving traffic compared to total available time, including time spent in overhead operations, such as polling terminals that return no data or do not respond, transmitting RF link packet overhead, collisions, etc. If many terminals have traffic when they are polled, polling may provide very high channel efficiency. However, at some times only a few terminals may have traffic to send. In that case, each terminal that has traffic to send is only allowed to transmit for a brief period of time and then must wait for all other terminals to be polled before it can transmit another payload. The rest of the time is essentially wasted in the overhead of polling terminals with nothing to send. In the extreme case where only one terminal has traffic to send the resulting channel efficiency will be very low if polling is used.

On the other hand, for CSMA/CA operation in an environment in which only a single wireless modem has traffic to send, the channel efficiency may approach 100%. But as the number of active wireless modems increases the collision rate increases and channel efficiency may become quite low. In fact, if too many wireless modems try to use the same RF channel, a condition known as channel collapse can occur, effectively rendering the RF channel unusable.

For polling operation the channel efficiency is greatest during periods of heavy traffic and may approach 100%. As the number of terminals active decreases the channel efficiency may decrease significantly. For example, in a typical outdoor wireless data network the distance between the base station and terminals may be 10 miles. Based on current IEEE 802.11b physical layer technology, using direct sequence spread spectrum with a raw signaling rate of 11 megabits per second, a polling operation between a base station and a terminal in which no payloads are exchanged will require approximately 0.5 milliseconds. For the same environment, if the base station and the terminal each transmit the maximum allowable payload size (e.g., 1518 octets for an Ethernet network) during the exchange, a total of approximately 2.7 milliseconds will be required (1.1 millisecond for each transmission of 1518 octets). Ideally this would mean that the maximum efficiency of the RF channel is approximately 82% (2.2/2.7). If only the terminals transmit payloads, then approximately 1.6 milliseconds will be required, resulting in a channel efficiency of approximately 70%. If the base station is associated with 100 terminals, the worst-case channel efficiency (when only one terminal of the 100 has traffic to send) is approximately 2%.

From the discussion above it is evident that channel efficiency could be improved over both known polling methods and CSMA/CA by using polling if unnecessary polling of inactive or out-of-service terminals could be reduced. The fundamental problem in determining in what order to poll the terminals to maximize channel efficiency while maintaining acceptable service to all is that the base station does not know a priori when reverse traffic will arrive at a terminal and therefore when to poll it to receive that traffic.

Another measure of interest is how the available transmission time is divided between terminals in a point to multi-point network. In many applications it is useful to ensure that each terminal gets a known fraction and/or a guaranteed allocation of the available time, along with guarantees about how that time is distributed. This is referred to as “Grade of Service.” The centralized control of a polling scheme lends itself very well to controlled grade of service. For example, the basic (round robin) polling scheme above ensures that each terminal gets an equal opportunity to transmit and receive data. Alternately, the order of polling could be re-arranged such that one terminal was polled twice as often as the others, or once every 50 ms or at some other desired rate.

### SUMMARY

Accordingly, the present invention is a method for polling a plurality of wireless modems from a base station. Each modem must be in one of three states at any one time. The three states function as follows: modems in the first state are not polled by the base station; modems in the second state are polled frequently by the base station; and modems in the third state are polled less frequently by the base station than modems in the second state. Modems change states according to set rules.

The following are examples of the aforementioned rules relating to changes in states:

a) a modem in the first state that has data to send to the base station may only attempt to send such data during random access polling periods and when data sent in such a manner is received by the base station the modem transfers to the second state;

b) a modem in the second state changes to the third state if for more than a predefined first interval it has not sent data to the base station in response to a poll and the base station has not sent data to it;

c) a modem in the third state changes to the first state if for more than a predefined second interval it has not sent data to the base station in response to a poll and the base station has not sent it data; and

d) a modem in the third state changes to the second state if it sends data to the base station in response to a poll or if the base station sends it data.

The preferred embodiment of the method of choosing the next modem to be polled is governed by a set of four rules that are followed in order. All methods of choosing the next modem to be polled will involve the application of a set of heuristics applied to the head of each list on a per poll basis.

The first rule states that if a positive result is derived from either of two calculations (as follow) the next modem chosen for polling will be the modem in state corresponding to the most positive result that was polled the least recently. The results are determined as follows:

a) The result of subtracting a preselected maximum inter-poll space criterion for modems in the second state from the time since the least recently polled modem in the second state was last polled.

b) The result of subtracting a preselected maximum inter-poll space criterion for modems in the third state from the time since the least recently polled modem in the third state was last polled.

The second rule states that if at least one of the results of two calculations (as follow) is positive the next modem chosen for polling will be the modem in a state corresponding to the most positive result that was polled the least recently and for which the time since the least recently polled modem in that state was last polled exceeds a preselected minimum inter-poll space criterion for modems in that state. The results are determined as follows:

a) The result of subtracting a preselected ideal inter-poll space criterion for modems in the second state from the product of the low pass average time between past polls of the modems in the second state and the number of modems in the second state.

b) The result of subtracting a preselected ideal inter-poll space criterion for modems in the second state from the product of the low pass average time between past polls of the modems in the third state and the number of modems in the second state.

The third rule states that if at least one of the results of two calculations (as follow) is positive the next modem chosen for polling is the modem in a state corresponding to the most positive result that was least recently polled for which the time since the least recently polled modem in that state was last polled exceeds a preselected minimum inter-poll space criterion for modems in that state. The results are determined as follows:

a) The result of multiplying the low pass average time between past polls of the modems in the second state of a preselected ratio for modems in the second state.

b) The result of multiplying the low pass average time between past polls of the modems in the third state by a preselected ratio for modems in the third state.

The fourth rule states that a random access polling period is provided to allow modems in the first state to attempt to send data to the base station.

### BRIEF DESCRIPTION OF DRAWINGS

FIG. 1 illustrates the use of wireless modems to provide a wireless bridge between two local area networks.

FIG. 2 is a schematic representation of typical RF link packet that would be transmitted from one wireless modem to another using protocol layering.

FIG. 3 is a schematic drawing showing a conventional point to multi-point wireless data communication network.

FIG. 4 is a schematic drawing showing conventional CSMA/CA techniques in which a base station or wireless modem wishing to transmit data on the radio link first listens to determine if the base station or other wireless modems are currently transmitting.

FIG. 5 is a schematic drawing showing how collisions can occur in a wireless network using CSMA/CA due to “hidden nodes”.

FIG. 6 is a schematic drawing showing how collisions due to high traffic load or hidden nodes can be avoided by using polling.

FIG. 7 is a schematic representation of an RF link packet that would be transmitted from one wireless modem to another using protocol layering in a preferred implementation of the invention.

FIG. 8 is a flowchart illustrating the overall polling method of a preferred embodiment of the invention.

FIG. 9 is a schematic representation showing a continuum of polling cycles.

FIG. 10 is an EUM state diagram.

FIG. 11 is a graph showing net throughput per terminal for 100 terminals averaging a 60 kbyte HTTP transmission every 2 minutes.

FIG. 12 is a graph showing numbers of active terminals for 100 terminals averaging a 60 kbyte HTTP transmission every 2 minutes.

FIG. 13 is a graph showing net throughput per terminal for 300 terminals averaging a 60 kbyte HTTP transmission every 2 minutes.

FIG. 14 is a graph showing numbers of active terminals for 300 terminals averaging a 60 kbyte HTTP transmission every 2 minutes.

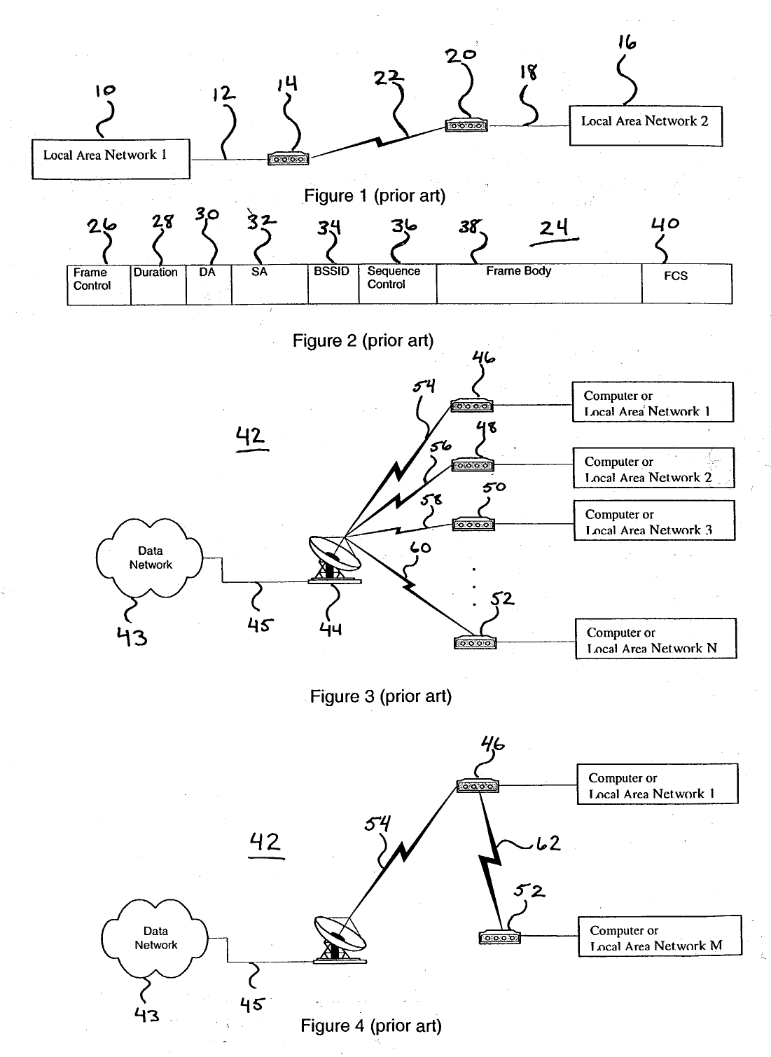

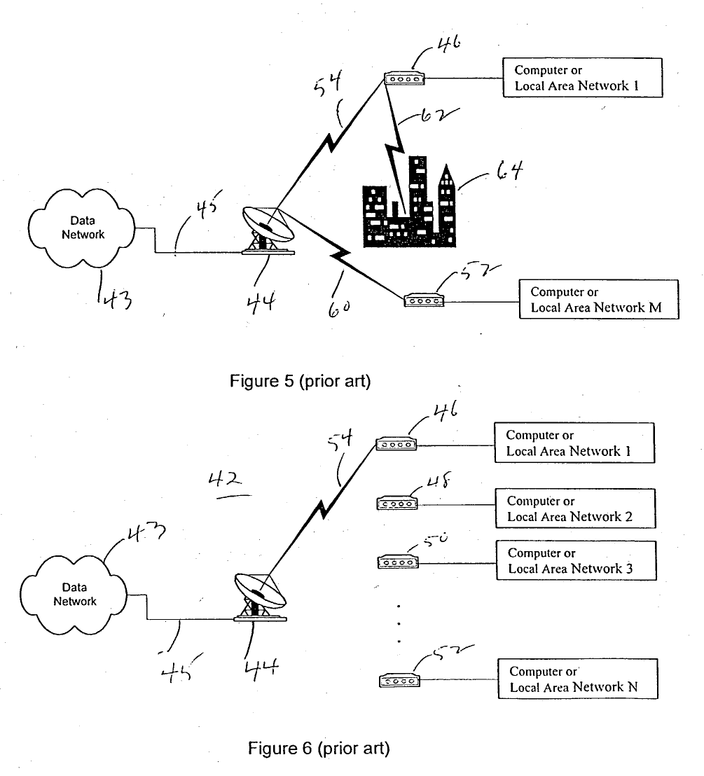

### DETAILED DESCRIPTION

In the following discussion a “directed poll cycle” consists of a transmission by the base station containing data identifying a single target terminal and the response (or lack of response) by that target terminal—all terminals having been programmed so that only the target terminal attempts to respond. The transmission by the base station may also contain a data payload intended for the target terminal and/or an acknowledgement for a data payload previously sent by either the target terminal or another terminal. The transmission by the base station is called a “directed poll.” The response from the target terminal may be a transmission that contains a data payload or an indication that it has no data payload to send. The transmission may also contain an acknowledgement for a data payload previously sent by the base station and/or further information that may be useful in determining when to next poll that terminal. Finally, the target terminal may not transmit at all, either because it did not receive the directed poll correctly, because it is deemed more efficient to not respond when it has no data payload to send or because it is disabled. In the following discussion it is assumed that those are the possible behaviors, but those skilled in the art will understand that other behaviors may be possible. A transmission by the target terminal is called a “directed response.” Note that collisions should not occur.

In the following discussion a “random access poll cycle” consists of a transmission by the base station containing data identifying a subset of existing terminals (the subset may include all terminals and may be defined dynamically) and the response(s) or lack of response by one or more of the subset of terminals—all terminals having been programmed so that only those in the subset may attempt to respond. The transmission by the base station may also contain a data payload and/or an acknowledgement for a data payload previously sent by a terminal. The transmission by the base station is called a “random access poll.” It simplifies an ARQ scheme if the data payload sent with a random access poll does not require an acknowledgement—which is often the case for broadcast traffic. Since in this case it is possible that more than one terminal may respond, a means is required for the terminals to avoid or recover from a collision. First, only terminals in the subset with data to send may respond. The means of avoidance may be a CSMA/CA approach as previously described, but that suffers from hidden node problems. In the preferred implementation the terminal responds to the first random access poll after a payload arrives, then, if no acknowledgement is received, waits a uniformly distributed random number of random access polls before responding again, repeating a fixed number of times before discarding the payload. Due to the possibility of collision, it is best to minimize the number of responses to random access polls, so terminals that are expecting to be directly polled shortly should not respond. An ARQ scheme helps in both cases, as a means to recover from collision. A transmission by a terminal may contain a data payload, an acknowledgement for a previously sent data payload from the base station, a request to be directly polled and/or further information that may be useful in determining when to next poll that terminal. This transmission is called a “random access response.”

In general, poll cycles—either directed or random access—follow one another with such time between as is deemed necessary or desirable. The base station may also transmit a packet to which no terminal is permitted to respond—useful for broadcast traffic in systems not using random access.

Note that while in the preferred implementation all transmissions are either from or to the base station, a system could be designed in which terminals transmitted data payloads directly between themselves. The problem of allocation of transmission time remains the same. The preferred implementation has the advantage that terminals need only to be able to communicate with the base station and not with all other terminals, greatly simplifying the RF engineering task and generally expanding the geographic coverage area. It also simplifies the implementation of ARQ schemes.

In the embodiment of the invention following, the base station determines which terminal transmits and when it will do so, except in the case of a random access poll, in which case the base station determines when a transmission will occur, but not which terminal will transmit.

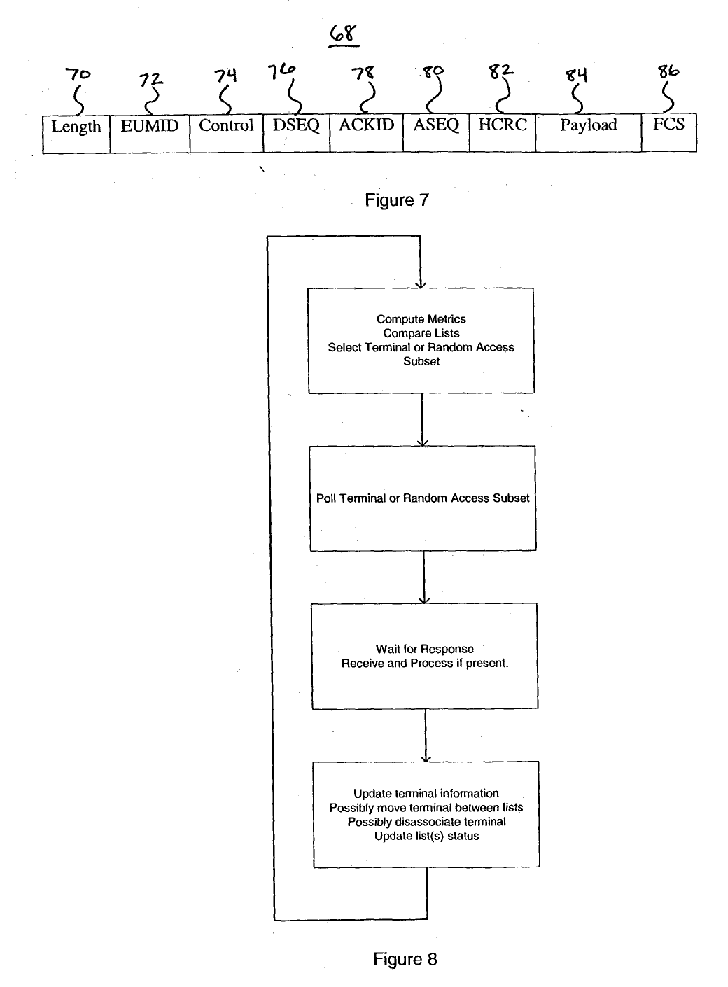

The RF link packet format 68 used in the preferred implementation is shown in FIG. 7. It may be further encapsulated by a physical layer packet header and/or trailer. The fields in the packet are:

Length 70—The length of the frame in bits.

EUMID 72—If transmitted by the base station this is a unique identifier of the terminal or a random access subset that is expected to receive the payload. If transmitted by a terminal, it is that terminal's unique identifier. Since RF is a broadcast medium all wireless modems in the receiving area will receive the RF link packet 68. If transmitted by the base station, only the terminal or random access subset that has this identifier, in this case wireless modem 20, is expected to process the payload. If transmitted by the terminal, only the base station is expected to process this packet. All other wireless modems receiving RF link packet 68 are expected to discard the payload.

Control 74—Information about the packet and the wireless modem transmitting it, including whether it was transmitted by the base station or a terminal, whether a valid acknowledgement is included in the packet and whether there are further data payloads waiting to be transmitted to or from the terminal.

DSEQ 76—The sequence number of the payload, if present, used for ARQ.

ACKID 78—If transmitted by the base station, this is the unique identifier of the terminal to which the acknowledgment in ASEQ, if present, applies. Only that terminal is expected to process the acknowledgement. If transmitted by the terminal, it is blank.

ASEQ 80—If transmitted by the base station and an acknowledgement is present, this is the sequence number of the last correctly received payload from the terminal identified by the ACKID. If transmitted by the terminal and an acknowledgement is present, this is the sequence number of the last correctly received payload from the base station to that terminal.

HCRC 82—The header cyclic redundancy check. This is a value that is calculated from all of the previous data in the RF link packet 68. The destination modem recalculates the HCRC 82 based on the data it receives. If the calculated value matches the value of the received HCRC 82, then the header information is considered to have been correctly received. Otherwise the packet is discarded.

Payload 84—The data payload portion of the RF link packet 68, if present.

FCS 86—The frame check sequence. This is a value that is calculated from all of the other data in the RF link packet 68. The destination modem recalculates the FCS 86 based on the data it receives. If the calculated value matches the value of the received FCS 86, then the payload is considered to have been correctly received. Otherwise the payload is discarded.

The basic polling structure of the preferred implementation is illustrated in FIG. 9. The base station begins each poll cycle by transmitting a packet, which may contain a data payload, to a terminal or a random access subset. An interframe space later the terminal replies with a packet that contains an acknowledgement for the last correctly received data payload. The packet may also contain a data payload. An interframe space later, the base station begins the next poll cycle with a packet to a (possibly different) terminal which contains an acknowledgement for the last correctly received data payload from the previously polled terminal. An acknowledge repeat request (“ARQ”) scheme, using acknowledgements and retransmissions to recover from message losses due to collisions or radio link errors, provides reliable transport.

Channel efficiency is maximized when either a payload is included with a poll or the response includes a payload or, even more so when both occur. The base station can use the information it has about each terminal including any or all of the following: whether there is a forward payload to send to it, whether it has indicated that it has a reverse payload outstanding (using the control field), the recent history of that terminal, contents of the payloads through it and outside information provided by an operator; to determine what order the terminals should be polled in to maximize channel efficiency. The base station does not know when reverse payloads will arrive at the terminal, but generally the probability that a terminal will have a reverse payload to send increases as the time between polls for that terminal increases. This is constrained by a limited acceptable latency for most payloads. That is, a terminal must be able to transmit a payload within a certain time of receiving it in order to offer acceptable service. The base station may also be constrained by service level agreements designating the grade of service offered to each terminal. The invention offers a computationally tractable method to make these tradeoffs.

Many data traffic sources exhibit traffic distributions that are described well by an ON/OFF model at some time scales. That is, a traffic source produces payloads relatively close together for some “ON” time period, followed by an “OFF” time period in which no payloads are produced. This may be observed at multiple time scales: for example, a traffic source may have several ON and OFF periods on the order of a second or two, followed by an OFF period of several minutes, followed by several more short ON and OFF periods. At the scale of minutes, the short ON and OFF periods can be viewed as a single ON period. At the smallest time period the source is ON while it transmits a payload and OFF in between payloads. The result of this is that the probability of a reverse payload arrival at a terminal during a given time period is significantly higher if a reverse payload has arrived recently than if none have arrived for some time. As most applications produce bi-directional traffic between two points, the probability of arrival at the terminal is similarly higher if a forward payload has been sent to the terminal recently.

The current invention allows the base station to take advantage of this in increasing channel efficiency through two mechanisms.

The first mechanism is to poll terminals that have had traffic recently (“active terminals”) more often, or with a different interval, than those that have not (“inactive terminals”). The result of this policy is that the first payload of a set (at the beginning of an ON period) may have a longer latency than following payloads. In most applications this is acceptable. As the difference in polling interval between active and inactive terminals grows, so, in general, do both the efficiency and the maximum latency.

The second mechanism uses the concept of association to ensure that terminals that have been inactive for an extended period (the “disassociation time”) or out of service will not be polled directly, eliminating the overhead of unused directed poll cycles. A terminal that is associated is directly polled by the base station at some interval determined by the above considerations and does not respond to random access polls. A terminal that is not associated (“disassociated”) belongs to at least one random access subset and may request to become associated with a random access response. This is usually due to the arrival of a reverse payload. The base station may cause a terminal to become associated when a forward payload arrives for a disassociated terminal, delivering the payload with a directed poll. Either the base station or a terminal may inform the other that the terminal has become disassociated, or they can each determine separately whether the terminal should be disassociated. In the preferred implementation the base station sends a message with a directed poll informing the terminal that it has been disassociated. The terminal may respond with an implicit request to remain associated.

As was stated previously, the result of disassociation is that the first payload of an ON period may have a longer latency than following payloads. The latency is related to the frequency of random access polls, the number of retries required due to collisions and the number of random access polls backed off between retries. The probability of collision is related to the ratio of the frequency of random access polls to the frequency (and distribution) of random access responses. If the disassociation time is made long enough the majority of traffic will pass across a directed poll cycle. There is, then, a tradeoff between a shorter disassociation timeout, which would presumably increase the number of random access responses but reduce overhead at the end of an ON cycle and a lower random access poll rate, which would increase the probability of collision and therefore the distribution of latencies but reduce overhead due to unused random access polls. Note that not all traffic follows the ON/OFF form and some provision may be made for traffic with other known forms.

A system using association and random access poll cycles is essentially a hybrid between a pure polling system and a distributed coordination function system such as CSMA/CA. If most traffic passes across a directed poll cycle and few terminals at a time are making use of the random access opportunities, then the high channel efficiency of a distributed coordination function system under low load is seen for those terminals while the high channel efficiency of a polling system under high load is seen for the majority of traffic.

The base station may be further constrained in determining what order and at what times to poll the terminals in by parameters describing different grades of service desired for different terminals. This “outside information” may be used to prefer one terminal over another at one time or one time over another for a terminal. Different active timeouts or disassociation timeouts may apply to different terminals. Terminals may be divided into different random access subsets on this basis, with different random access poll rates or distributions for different subsets.

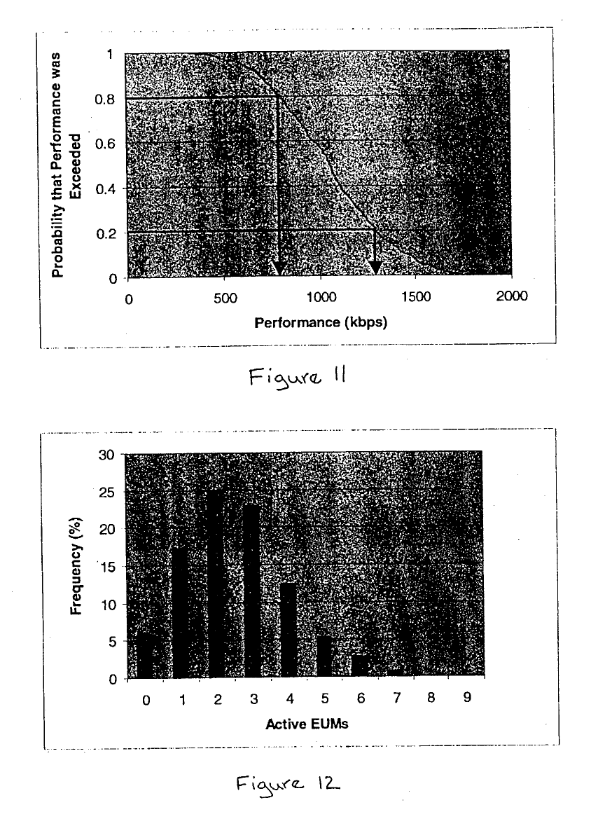

The grade of service (“GOS”) as shown in FIG. 10 essentially corresponds to the following: how often a terminal is polled; how quickly it starts to be polled if it is not being polled when a packet arrives; how limited poll opportunities are apportioned between terminals of different grades of service; and how determination of activity level or association is made. A strictly best effort service arises if each terminal is simply polled in turn. Different grades of service can be provided to different terminals by polling one more or less often than others, or by polling a terminal at a known rate. In the preferred implementation a terminal can only send one packet each time it is polled, thus the data rate is related to the polling rate. Different grades of service arise from different selections of active and disassociation timeouts, or other parameters, used in the process of selecting terminals to be polled.

Before describing embodiments of the inventive method in detail it may be helpful to the reader to describe generally the principles applied in each embodiment. Ideally, the base station would compare each terminal and random access subset before each poll to determine the best choice to achieve maximum possible channel efficiency and acceptable grade of service. However, as the number of terminals grows, this quickly becomes computationally expensive. To reduce the computational load, terminals with similar states can be grouped into lists so that only one terminal at a time from each list need be considered. Moving terminals from one list to another and/or using disassociation can reduce the disadvantage that a polling system has under some conditions, as compared to a contention-based system, as the number of null responses and no responses are reduced. So, fundamentally, the basis of all of the embodiments is the dynamic updating of multiple lists of terminals by the base station based upon the historical behavior, reported state and grade of service of the terminals. Having more than one list of terminals allows for such innovations as changing in real time the relative frequency and/or latency with which the terminals identified on each list are polled, so as to maximize the efficiency of the use of the communications medium, in this case the RF channel, while maintaining acceptable defined grades of service.

In the preferred embodiment, terminals are allocated to groups. Each terminal in a group is offered the same grade of service. For each group there are two lists of associated terminals, one labelled active and the other labelled inactive. Associated terminals are placed on the active list of their grade of service. Such terminals remain on the active list for their grade of service until there is a short interval in which there is no traffic to or from such terminal. At that point the terminal is moved to the inactive list and is consequentially polled less often. If any traffic appears to or from such terminal it is moved back to the active list. Terminals on each list are polled in a round-robin fashion, but each poll may be from any list. A disassociated terminal is removed from the lists. It is possible to allocate terminals in different groups based on active, inactive or disassociated states, though it obviously increases the required management. It is also possible to change the grade of service assigned to a terminal for a range of reasons. The management of the grade of service allocations is outside the scope of this patent.

While the above mechanisms are optimized for the ON/OFF characteristics of most data traffic, grade of service parameters can be manipulated to efficiently deal with constant rate traffic as well.

In addition to efficiently managing the usage of the radio link, and providing differentiated service capabilities, a well-designed polling algorithm, such as that described will “smooth” the upstream (terminal-to-base-station) packet arrival times. This also has a smoothing effect on the downstream traffic arrivals, which in turn positively impacts network performance by reducing all of the following surges in data traffic; transients in queue occupancy; and packet discards.

In the embodiments described, only one terminal per list (at the list “head”) is considered on each poll cycle, with the selected terminal moving to the list “tail” at the end of the cycle. It is possible to consider more than one terminal in each list and reorder them if desired, but this involves a higher computational load and more storage.

The first step in applying the inventive method is to form at least two lists. In the description that follows six embodiments are described using:

1. Two lists for active and inactive terminals (without disassociation).

2. Three lists for active and inactive terminals plus random access subsets.

3. Multiple lists for terminals with different grades of service (without disassociation).

4. Multiple lists for terminals with different grades of service plus lists for random access subsets of different grades of service.

5. Multiple lists for active terminals of different grades of service and multiple lists for inactive terminals of different grades of service (without disassociation).

6. Multiple lists for active terminals of different grades of service and multiple lists for inactive terminals of different grades of service plus lists for random access subsets of different grades of service.

Those skilled in the art will understand that additional sets of lists, for example classifying terminals in categories other than active and inactive, may be useful under certain circumstances. Disassociated terminals may be considered to be on a “virtual” list or may be kept on an actual list.

In all embodiments described, the lists are initially populated by operator provisioning and/or as traffic arrives at the base station and/or, if random access is used, by random access. However, the initial lists could be obtained in some other manner and provided to the base station. Lists may be empty.

In the following discussion, lists of terminals will be described as if each list were stored separately as a discrete list. As those skilled in computer programming will understand, the inventive method could be implemented using a single list having a discrete entry for each modem and a flag or indicator of some kind associated with each entry to distinguish the entries that would otherwise be stored in discrete lists. That and other equivalent implementations are intended wherever, in the following description and in the claims, reference is made to more than one list of terminals.

In all embodiments described, the decision as to which terminal (or random access subset) to poll is made immediately before the poll at a time when all information from the previous poll is available. Practical limitations may require that this decision be made earlier, when slightly less information is available.

Each of the embodiments of the inventive method that are described below may be applied in a system such as a point to multi-point wireless data communication network 42 shown in FIG. 6.

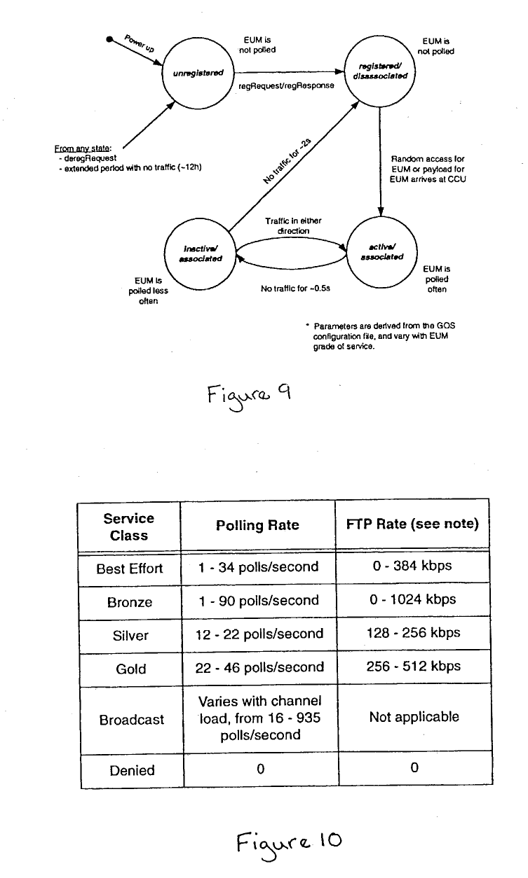

Each of the embodiments of the base station uses the same basic procedure for each polling cycle, as shown in FIG. 8 and described below. In the text that follows, whenever a terminal is referenced, a random access subset may also be referenced.

The basic procedure includes the following steps:

1. The base station calculates and compares a set of metrics for the terminal at the head of each list based on information maintained for each of the terminals and for each list. The terminal with the “winning” metrics is selected for polling. An empty list cannot be selected. This process functions in a manner that is similar to a task scheduler, with each list corresponding to an on-going task. Some of the information about the terminal that may be used in the metrics includes: the time that the terminal was last polled; whether the last poll contained a forward payload; whether the last response contained a reverse payload; the number of forward payloads available for the terminal; the number of reverse payloads reported by the terminal on the last poll; an average of the rate at which the terminal has been polled over some interval; a measurement of the recent traffic for the terminal; the number of consecutive times no response has been received to a directed poll of the terminal; the retries required due to packet loss; the characteristics of the payloads carried, such as TCP syn/fin flags, protocol, TOS or QOS fields; and whether service level guarantees have been met lately. Similar information about the list as a whole may be used as well including: the last time a terminal from the list was polled; average time between polls for terminals on the list; and the number of terminals on each list. Parameters for the metrics may vary depending on the list. Generally the metrics determine the grade of service for each list. In the preferred implementation four metrics are used:

A. First, if the time since the terminal was last polled is less than the minimum inter-poll space parameter for the list that terminal is on, the terminal is disqualified.

B. Second, if the time since the terminal was last polled is near or greater than the maximum inter-poll space parameter for the list it is on, the metric is equal to the difference. The terminal with the largest metric is selected. This implementation can be used to enforce a maximum latency between polls.

C. If no terminal is selected by rule B, a low-pass moving average of the time between polls for terminals on the list is calculated assuming the terminal is selected. If this calculation result is near or greater than the ideal time between polls for the list, the metric is equal to the difference. The terminal with the largest metric is selected. This implementation can be used to enforce an average polling rate which in turn enforces an average throughput.

D. If no terminal is selected by implementation B or C, a low-pass moving average of the time between polls for terminals on the list is calculated assuming the terminal is selected. The metric is equal to this average time multiplied by the ratio parameter for the list. The terminal with the largest metric is selected. By this implementation on average a terminal in a list with a ratio of 4 will be polled 4 times as often as one in a list with a ratio of 1.

Finally, if no terminal has been selected, a random access subset is selected.

2. The base station transmits a directed or random access poll to the terminal or random access subset selected, including any forward payload available for that terminal or random access subset.

3. The base station waits a known period for a response.

4. If a response is received correctly, the base station processes any payload and/or acknowledgement.

5. The base station updates the information maintained for the terminal and the list it is on, based on the received response (or lack thereof).

6. If the base station determines that the terminal should be reassigned from an active to an inactive state, or from an inactive to an active state, it will move the terminal to the list that corresponds to the changed designation of the terminal and update the information maintained for the prior and present lists to reflect the removal or addition of the terminal. In the preferred implementation, the base station moves a terminal from an active to an inactive state if no traffic (forward or reverse) for that terminal has been experienced for longer than the “active timeout” parameter for the list. The base station moves a terminal from an inactive to an active state when any traffic (forward or reverse) is experienced for that terminal.

7. If the base station determines that the terminal should be disassociated, it may inform the terminal that it has been disassociated and then remove it from its current list and update the information maintained for the list to reflect the removal of the terminal. Some embodiments do not support disassociation. In the preferred implementation, the base station disassociates a terminal if no traffic (forward or reverse) for that terminal has been seen for longer than the “disassociation timeout” parameter for the list or if it has not responded to a certain number of consecutive polls. The base station sends a special packet to the terminal using a directed poll to inform the terminal of this. The terminal may respond with a reverse payload, in which case it remains associated.

8. If a random access response is from a terminal that is not associated (which is the expected case) and includes a request to associate (which may be implicit), the base station will place it on the active list corresponding to the grade of service required by that terminal. It may send a special packet to that terminal using a directed poll to inform the terminal that it is associated, or that may be implicit in either an acknowledgement for the response or in the presence of a directed poll. Some embodiments do not support random access. In the preferred implementation, the terminal includes a payload with a random access response, which is an implicit request to associate. It determines that it has become associated when it receives a directed poll.

9. If the base station determines that a terminal should be given a different grade of service, it may move the terminal from its current list to the corresponding list of the new grade of service, updating the information maintained for the two lists accordingly.

10. The base station moves the terminal to the end of its list.

11. This step may be done asynchronously to the others. If a forward payload arrives at the base station for a terminal that is not associated—not on a list—the base station will place it on the active list corresponding to the grade of service required by the terminal. The information maintained for that list is updated to reflect the addition of the terminal. If a forward payload arrives at the base station for an associated terminal, the terminal may be moved from an inactive to an active list.

In a first implementation, two lists are maintained: one for active terminals and one for inactive terminals. If a terminal has not had a payload either to or from it for a specified time it is placed on the inactive list. On arrival of a payload in either direction, the terminal is placed on the active list.

A second implementation adds a third list to the first implementation with entries for each random access subset (there may only be one) plus the following rules. If a terminal has not had a payload either to or from it for a longer specified time it is disassociated and removed from the inactive list. When a terminal makes a random access with a payload it is considered associated and placed on the active list.

In a third implementation, several lists are maintained: one for each grade of service offered. Terminals are placed on the list corresponding to the grade of service allocated to it. The process controlling allocation of terminals to grades of service is outside the scope of this patent.

A fourth implementation adds another set of lists to the third implementation for each random access grade of service (there may only be one) with entries for each random access subset (there may only be one) as allocated and the following rules. If a terminal has not had a payload either to or from it for a longer specified time it is disassociated and removed from its list. When a terminal makes a random access it is considered associated and placed back on the list corresponding to the grade of service allocated to it.

In a fifth implementation, several pairs of lists are maintained: one pair for each grade of service offered. One list of each pair is for active terminals and the other for inactive terminals of that grade of service. If a terminal has not had a payload either to or from it for a specified time it is placed on the inactive list corresponding to the grade of service allocated to it. On arrival of a payload in either direction, the terminal is placed on the active list of the pair.

A sixth and preferred implementation adds another set of lists to the fifth implementation for each random access grade of service (there may only be one) with entries for each random access subset (there may only be one) as allocated and the following rules. If a terminal has not had a payload either to or from it for a longer specified time it is disassociated and removed from its list. When a terminal makes a random access it is considered associated and placed back on the active list corresponding to the grade of service allocated to it.

Those skilled in the art will recognize that more combinations of lists and rules are possible in different situations.

A more detailed description follows of an embodiment of the invention for use in a 900 MHz radio network data transmission system, which takes advantage of patterns found in typical Internet usage. The scope of the discussion is limited to the media access control (“MAC”) layer. It is assumed that the reader has a basic understanding of the physical layer. Based on the terminal's subscribed grade of service and current traffic level, the base station continuously adjusts the rate at which the terminal is polled. This process is illustrated in the terminal state diagram in FIG. 10.

When a terminal first powers up, it is in an unregistered state. In the unregistered state, the terminal is not being polled, and is therefore not passing traffic. An unregistered terminal sends a registration request to the base station as a random access response. If the terminal is authorized, the base station will reply with a registration response which contains basic configuration as a directed payload and the terminal will become registered while remaining disassociated. In the registered and disassociated state, the terminal is still not being polled. But if the terminal has traffic to send, it will make a random access response and as a result will become associated. The terminal may also become associated if the base station has a payload to send to the terminal. Once associated, the state of the terminal will change to be active and associated.

In the active and associated state, the terminal is polled frequently at a rate consistent with its subscribed grade of service. If there is no traffic to or from an active and associated terminal for a defined interval (typically set around 0.5 seconds), the state of the terminal will be changed to inactive and associated. The terminal is not informed of this change.

An inactive and associated terminal will be polled less frequently than when it was active and associated. If traffic is resumed, the state of the terminal will change back to active and associated. If there is no traffic for a longer defined interval (typically set around 2 seconds), the base station will send the terminal a disassociation request and the state of the terminal may change back to registered and associated.

If a terminal is issued a deregistration request, for any reason, or if it has no traffic for an extended period of time, 12 hours or so, its state may be changed back to unregistered.

The base station assigns each terminal to a grade of service class. For each class there are two lists of associated terminals labeled “active” and “inactive”. Terminals associating are placed on the active list for their grade of service and remain there until there is a short interval in which there is no traffic to or from such terminal. At that point the terminal is moved to the inactive list and polled less often. If any traffic occurs to or from that terminal such terminal is moved back to the active list. Terminals on each list are polled in a round-robin fashion, but each poll may be from any list.

There is also a broadcast and random access list.

The base station uses the metrics described in step 1 of the basic procedure above with the parameters that follow. Each list, active and inactive, has its own set of values.

| | |
|---|---|
| maxIPS | Maximum Inter-poll space (μs). The maximum allowable time |
| | between polls for each terminal on the list. Effectively disabled |
| | if made very large. Highest priority. |
| minIPS | Minimum Inter-poll space (μs). The minimum allowable time |
| | between polls for each terminal on the list. Disabled if set to 0. |
| | Second priority. |
| idealIPS | Desired Inter-poll space (μs) for each terminal on the list |
| | averaged over time and all terminals in the list. Effectively |
| | disabled if made very large. Third priority. |
| ratio | Polling ratio for the list as used for weighted best effort polling. |
| | Disabled if set to zero. Lowest priority. |

In addition, each class has two parameters:

| | |
|---|---|
| activePollListTimeout | If no traffic flows to or from the terminal for |
| | this long (μs) the terminal will be moved |
| | from the active to the inactive list. |
| disassociationTime | If no traffic flows to or from the terminal for this |
| | long (μs) the terminal will be disassociated. |

The collection of parameters allow for a very flexible definition of grade of service, but consideration should be given to a number of interactions between the parameters and the averaging. Some recommended classes are discussed below.

The broadcast and random access class parameters will determine how well the random access mechanism works. As the number of terminals in the system and/or the use of those terminals increases, the number of random accesses will also increase, meaning that the number of available random access polls must increase. However, unused random access polls are overhead.

With the short disassociationTime's suggested below, most user interactions (e.g. an HTTP GET triggered by a “click”) will begin with a random access. The delay for this first packet is likely to be the longest, especially due to the possibility of collisions and the random waits for retries. Since most of these transfers are for a small number of packets, this is often a significant fraction of total transfer time.

The parameter sets described below are sized for a system with between 200 and 1000 polls per second, depending on packet size; and up to 300 terminals with “average” residential user traffic loads.

In general, it is best if the random access poll interval is not related to the other activity on the channel, so the ratio should be zero. The average inter-poll space gets very low when no terminals are active, so a class based solely on idealIPS is not polled for a long period following the first association while the average grows slowly toward the target. A class based solely on maxIPS leaves little flexibility for other classes. Therefore a class based on both idealIPS and maxIPS is recommended, as follows:

| RANDOM ACCESS | inactive | active | |
|---|---|---|---|
| activePollListTimeout | | N/A (0) | |
| disassociationTime | N/A (0) | | |
| maxIPS | N/A (0) | 65,000 | μs |
| minIPS (minIPS in the | N/A (0) | 10,000 | μs |
| broadcast list is | | | |
| overridden by rule 4 of | | | |
| the algorithm) | | | |
| idealIPS | N/A (0) | 55,000 | μs |
| ratio | N/A (0) | 0 | |

This ensures between 15 and 18 random access polls per second (about 2% overhead) reasonably supporting 300 users making one access every 120 s (Poisson).

It is recommended that the majority of users be offered a “best effort” service, in which they will receive whatever time is left over when all other user's contracts have been met. This corresponds to the use of the ratio parameter and possibly the minIPS parameter. The point of interest here is the active to inactive ratio and the rate at which terminals are disassociated. A large ratio reduces the overhead of polling “inactive” terminals; but with many active terminals, a large ratio can lead to very long intervals for inactive terminals, possibly delaying a follow-on (or slow) transfer by more than a random access. The BEST EFFORT 1 class described below has a minIPS that corresponds to a maximum of 34 polls per second, which in practice translates to file transfer rates of up to 384 kbps with 1460 byte packets. A small minIPS on the inactive list decreases the random access times during non-busy periods.

Decreasing the activePollListTimeout will generally reduce the number of empty polls, but will increase the latency for slow links and follow-on transfers. Similarly, decreasing disassociationTime will reduce the number of empty polls, but increase the number of random accesses. Due to the possibility of collision (and multiple collision if the load is high), it is best to reduce the number of random accesses where possible. Measurements from a beta trial indicate that 0.5s and 2s respectively are good starting points.

| BEST EFFORT 1 | inactive | | active | |
|---|---|---|---|---|
| activePollListTimeout | | | 500,000 | μs |
| disassociationTime | 2,000,000 | μs | | |
| maxIPS | 2,000,000 | μs | 1,000,000 | μs |
| minIPS | 50,000 | | 29,000 | |
| idealIPS | 2,000,000 | μs | 1,000,000 | μs |
| ratio | 1 | | 9 | |

More than one “best effort” class could be defined, with different ratios and/or minIPS.

An attractive upgrade in grade of service from best effort is to “guarantee” a fixed transfer rate; however, since most of the time not all of this is used, it is inefficient to allocate the full amount all the time. The idealEPS parameter can be used to fix the average polling rate and therefore the throughput. Longer timeouts decrease the likelihood of long delays from random access (though with normal usage, not very much). An IPS of 42,000 μs corresponds to file transfer rates of about 256 kbps with 1460 byte packets.

| RATE BASED 1 | inactive | | active | |
|---|---|---|---|---|
| activePollListTimeout | | | 700,000 | μs |
| disassociationTime | 3,000,000 | μs | | |
| maxIPS | 200,000 | μs | 46,000 | μs |
| minIPS | 0 | | 0 | |
| idealIPS | 100,000 | μs | 42,000 | μs |
| ratio | 0 | | 0 | |

Under lightly loaded conditions, this can leave the “higher” GOS class user at a disadvantage compared to the best effort users, since the extra available time is not offered. Adding the ratio-based metric allows the user to “burst” above their assigned minimum. Again, a minIPS can enforce a maximum rate. This one allows for rates between 256 and 512 kbps, with burst rates 25% higher than the BEST EFFORT 1 class due to the higher ratio.

| RATE BASED 2 | inactive | | active | |
|---|---|---|---|---|
| activePollListTimeout | | | 700,000 | μs |
| disassociationTime | 3,000,000 | μs | | |
| maxIPS | 200,000 | μs | 46,000 | μs |
| minIPS | 60,0000 | μs | 21,300 | μs |
| idealIPS | 100,000 | μs | 42,000 | μs |
| ratio | 1 | | 12 | |

The design of the system has been optimized to allow maximized user capacity for typical patterns found in Internet usage, which include browsing the world wide web, assessing e-mail, transferring files, and streaming audio and video. The common characteristic of these uses is that they are bursty—data is transferred in “bursts”, with time in between the bursts when no data is transferred. As a result, not all users will be transferring data at the same time. In fact, the number of users that are actually transferring data at any one time is generally much smaller than the number sitting in front of their computers, which, in turn, is much smaller than the total number of end users. As a result, many users can share the radio link and, for the short time they need it, use a significant portion of the link bandwidth or, in other words, many users share the limited bandwidth of the channel, yet each perceives that they have most of the channel to themselves. This “over-subscription” model is the basis of Ethernet, DOCSIS cable networks, 802.11 radio networks, Bluetooth, and even, on a larger scale, the public switched telephone network.

Various operational objectives are factored into the determination of the grade of service parameters assigned to each class of terminals, including:

Maximize overall user capacity, and minimize the overhead related to empty polls;

Accommodate different types of data; for example, short, bursty data, such as email and browsing, and large file transfers;

Support differentiation of user classes, in terms of committed information and maximum burst rate throughput levels;

Control packet latency, to support interactive services such as VoIP and chat;

Support both symmetrical and asymmetrical data applications;

Control unauthorized web hosting or gaming applications;

Support multi-user network applications at a single terminal.

In practice, the bursty nature of Internet usage is such that variations in service level tend to be instantaneous and transitory. Overall, end-users tend to see a relatively high average throughput, consistent with their assigned GOS class. It is virtually impossible to deterministically calculate the performance of packet radio systems. However, using computer simulations, designed to accurately reflect the system implementation, and user and network traffic distributions, it is possible to produce statistical representations of system performance.

A model has been developed that simulates system processes, tasks, protocols, propagation delays, and queue sizes for the system described above. The model can simulate systems with large numbers of terminals and wide ranges of user traffic. The inputs to the model include the number and geographical distribution (distance from base station) of terminals, user traffic statistics, grade of service parameters and RF link-quality distributions. These inputs are based on our real-world experience with actual customer installations. The outputs of the model are statistical representations of system performance.

To illustrate the output of the model, consider the following example. First of all, the following general assumptions will be made:

900 MHz 2.75 Mbps raw channel rate;

There are no channel errors;

Servers are fast, and do not present a bottleneck;

There are no external link or backhaul bottlenecks;

Typical terminal to base station range is 0 to 3 km.

Secondly, it will be assumed that typical end-user traffic is Web browsing, averaging one 60 kbyte HTTP transfer every two minutes. This traffic pattern is based on analyses of busy-hour data collected from systems consisting primarily of residential users. In normal usage, users will randomly and independently download a file or Web page, take time to process the information, then download another file or Web page. If this type of traffic is assumed, we get the performance shown in FIG. 11, which shows net throughput per terminal for 100 terminals averaging a 60 kbyte HTTP transmission every 2 minutes. From FIG. 11, each of the 100 end users can expect a net throughput better than 800 kbps 80% of the time, and better than 1.3 Mbps 20% of the time.

The system performance can also be assessed based on the number of terminals that are associated at any given time. This is illustrated in FIG. 12, which shows numbers of active terminals for 100 terminals averaging a 60 kbyte HTTP transmission every 2 minutes. From FIG. 12, of 100 terminals, two were active 25% of the time, and seven were active less than 1% of the time. The amount of time eight or more terminals were active was negligible.

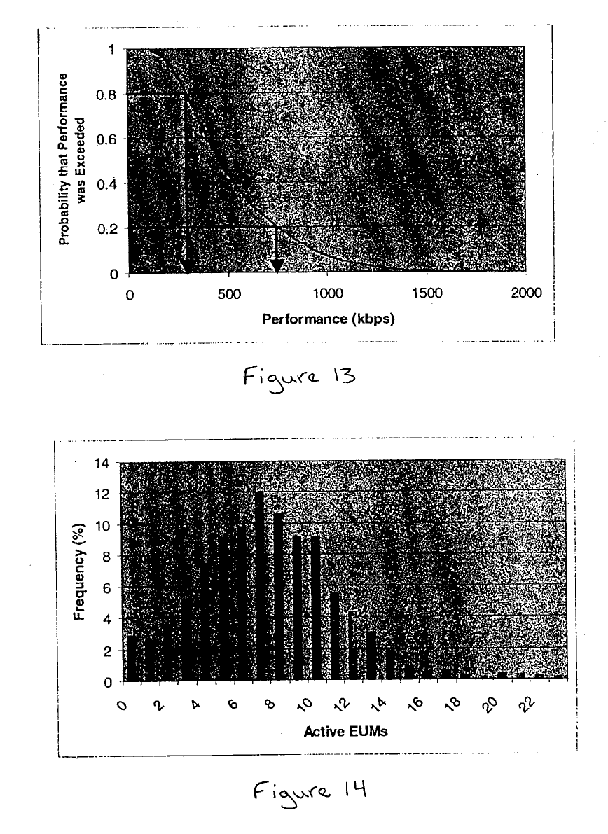

If the number of terminals is increased to 300, and the same level of traffic per terminal is maintained, the modeled performance becomes as illustrated in FIG. 13, which shows net throughput per terminal for 300 terminals averaging a 60 kbyte HTTP transmission every 2 minutes. From FIG. 13, each of the 300 end users can expect a net throughput better than 300 kbps 80% of the time, and better than 750 kbps 20% of the time. Once again, the system performance can be assessed based on the number of terminals that are associated at any given time. This is illustrated in FIG. 14, which shows numbers of active terminals for 300 terminals averaging a 60 kbyte HTTP transmission every 2 minutes. From FIG. 14, of 300 terminals, eight were active 12% of the time, and 14 were active less than 3% of the time. The amount of time 25 or more terminals were active was less than 0.4%.

All of FIGS. 11 to 14 illustrate that, as stated earlier, many users can share the limited bandwidth of the channel, yet most of the time, each perceives that they have most of the channel to themselves.

It will be apparent that may other changes may be made to the illustrative embodiments, while falling within the scope of the invention and it is intended that all such changes be covered by the claims appended hereto.

1. A method for polling a plurality of wireless modems from a base station in which each modem is considered to be in only one of three states at any one time, but changes between states according to a set of rules, and in which modems in a first state are not polled by the base station, modems in a second state are polled frequently by the base station, and modems in a third state are polled less frequently by the base station than modems in the second state, the rules including:
a rule that a modem in the first state that has data to send to the base station may only attempt to send such data during random access polling periods and when data so sent is received by the base station the modem changes to the second state;
a rule that a modem in the second state changes to the third state if for more than a predefined first interval it has not sent data to the base station in response to a poll and the base station has not sent it data;
a rule that a modem in the third state changes to the first state if for more than a predefined second interval it has not sent data to the base station in response to a poll and the base station has not sent it data; and
a rule that a modem in the third state changes to the second state if it sends data to the base station in response to a poll or if the base station sends it data.

2. The method of claim 1, wherein the next modem to be polled is chosen by applying the following rules:
a first rule under which if at least one of:
the result of subtracting a preselected maximum inter-poll space criterion for modems in the second state from the time since the least recently polled modem in the second state was last polled; and
the result of subtracting a preselected maximum inter-poll space criterion for modems in the third state from the time since the least recently polled modem in the third state was last polled,
is positive, then the next polled modem is the least recently polled modem in the state corresponding to the most positive result;
a second rule under which if no modem is chosen under the first rule and if at least one of:
the result of subtracting a preselected ideal inter-poll space criterion for modems in the second state from the product of the low pass average time between past polls of the modems in the second state and the number of modems in the second state; and
the result of subtracting a preselected ideal inter-poll space criterion for modems in the second state from the product of the low pass average time between past polls of the modems in the second state and the number of modems in the second state,
is positive, then the next modem chosen for polling is the least recently polled modem in the state corresponding to the most positive result for which the time since the least recently polled modem in that state was last polled exceeds a preselected minimum inter-poll space criterion for modems in that state;
a third rule under which if no modem is chosen under the first or second rules and if at least one of:
the result of multiplying the low pass average time between past polls of the modems in the second state by a preselected ratio for modems in the second state; and
the result of multiplying the low pass average time between past polls of the modems in the third state by a preselected ratio for modems in the third state,
is positive, then the next modem chosen for polling is the least recently polled modem in the state corresponding to the most positive result for which the time since the least recently polled modem in that state was last polled exceeds a preselected minimum inter-poll space criterion for modems in that state; and
a fourth rule under which if no modem is chosen under the first, second, or third rules, then a random access polling period is provided to allow modems in the first state to attempt to send data to the base station.
